(19) United States
(12) Patent Application Publication
(10) Pub. No.: US 2005/0087043 A1
(43) Pub. Date: Apr. 28, 2005

(54) Fastener driving tool

(76) Inventors: Henry K. Good IV, Swan Lake, MT (US); Kerry Bo Good, Swan Lake, MT (US)

Correspondence Address: Burkhart & Burkhart;Patent Attorneys, 940 Dakota Avenue, Whitefish, MT, 59937, US

(21) Appl. No.: 10/696,020

(22) Filed: Oct. 28, 2003

(51) Int. Cl. B25B 13/00

(52) U.S. Cl. 81/124.6

(57) ABSTRACT

A fastener drive system includes a fastener having a plurality of external drive surfaces. The system also includes a fastener driver having a plurality of drive blades. Each of the drive blades has a generally wedge-shaped cross section and a contact edge. The contact edge of each drive blade is adapted to engage one of the external drive surfaces during driving of the fastener by the fastener driver. In an embodiment, the fastener driver is provided as a cylindrical socket adapted for connection to a ratchet driver. The number of drive blades can correspond to the number of external drive surfaces, typically four or six. Alternatively, equally spaced blades can be provided corresponding to half the number of drive surfaces.

### FIELD OF THE INVENTION

The present invention relates generally to fastener driving tools. Specifically, the present invention relates to fastener driving tools having torque and grip enhancing profiles.

### BACKGROUND OF THE INVENTION

The invention and development of tool-driven fasteners has revolutionized virtually every technology imaginable, from spacecraft to children's toys. The ability to assemble components together in a secure and efficient manner is critical to manufacturing and maintaining almost every man-made object comprising more than one piece.

This is particularly important in those instances where components are assembled and reassembled repeatedly. Most modem fastener and driver systems are effective initially. Unfortunately, wear, abuse, and material fatigue eventually render the system useless, or at least much less effective than at the time of original installation. The areas in which this loss of effectiveness are most frequently evidenced is in the gripping force between the driving tool and the fastener, which in turn affects the torque that can be applied to the fastener by the tool.

Not surprisingly, grip and torque enhancing devices have been the subject of inventive activity as reflected in the patent literature. For example, U.S. Pat. No. 3,897,812 to Arnn relates to a screw driver including a blade which terminates in a lower foot portion which in turn protrudes outwardly from the blade faces to provide a gripping means. The gripping means imbeds itself into the sidewalls of the slot in a screw head to prevent the blade from slipping out of the slot as the screw driver is turned. Specifically, the Arnn patent is directed to a screw driver comprising a shank portion and a blade portion integral therewith, the blade portion having generally converging sides and generally converging edges terminating integral with a foot portion, said blade including torque transmitting ribs integral with said sides along the opposed edges of said blade, said foot portion defining the lower most portion of said blade and being generally isosceles trapezoidal in cross-section with its widest base portion lying in a plane perpendicular to the axis of said shank and being engageable with the bottom of a slot in a screw head and its inwardly tapered sidewalls extending across the entire width of the blade and being engageable with the parallel sidewalls of a screw head slot. The junction of said base and respective inwardly tapered sidewalls define wedge-like bites which cut a groove in the parallel sidewalls of said screw slot upon application of a torque to the shank.

In another example, U.S. Pat. No. 4,339,971 to Zatorre discusses a driving tool and fastener, in the driving end of which is provided a nick or slot for insertion of the driving tool for driving the fastener, are provided which, because of their particular, respective cross-sectional configurations, can be interlocked temporarily together. As this interlocking engagement prevents the driving tool from accidentally slipping from the nick in the driving end of the fastener, rotational movement of the fastener is greatly facilitated. The shank of the driving tool is provided at its operative end with a bit that, because of its cross-sectional configuration compared to that of the nick, wedges with the nick. Thus, not only is slipping between the driving tool and fastener prevented when rotating the fastener, but accidental separation of the driving tool from the fastener is prevented, making the task considerably easier when using the fastener in overhead work or in a hard to reach location.

Yet another approach is illustrated in U.S. Pat. No. 5,317,940 to Shun'ko. The Shun'ko patent pertains to a screwdriver blade including a shank having a central axis and a tip portion which extends from the shank. The tip portion has a pair of opposing concave driving faces and a concave terminal end surface. The concave driving faces are toroidal having a first radius R1 disposed in a plane which is parallel to the central axis. The first radius R1 has a center disposed at a distance x from a side edge of the concave terminal end surface. The concave driving faces have a second radius R2 disposed in a plane perpendicular to the central axis. The terminal end surface is cylindrical and has a third radius R3 which is disposed in a plane perpendicular to the plane through first radius R1. The tip portion has a width b and a maximum thickness c and preferably, 0.2b×0.5b, 0.2b R1b, R2=Kb2/c where K is a constant and 0.5R 2R32R 2 and the angle a between a line tangent to R1 at the maximum thickness c and the central axis is between 15° and 45°. In one embodiment, x=0.5b, R1=b, R2=0.32b 2/c and R3=R2 and a=30°.

While each of these patented devices offers some advantages over standard fastener and driver systems, it can be seen that the need exists for a simple, inexpensive, fastener driver that maintains its functionality despite the effects wear or damage on the various components of the system.

### SUMMARY OF THE INVENTION

These and other objects are achieved by providing a fastener drive system including a fastener having a plurality of external drive surfaces. The system also includes a fastener driver having a plurality of drive blades. Each of the drive blades has a generally wedge-shaped cross section and a contact edge. The contact edge of each drive blade is adapted to engage one of the external drive surfaces during driving of the fastener by the fastener driver.

In an embodiment, the fastener driver is provided as a cylindrical socket adapted for connection to a ratchet driver. The number of drive blades can correspond to the number of external drive surfaces, typically four or six. Alternatively, equally spaced blades can be provided corresponding to half the number of drive surfaces.

The blade surfaces can be configured as a pair of blade surfaces converging at the contact edge. For example, each drive blade comprise a bottom surface and an inclined surface wherein the bottom surface of the drive blade is substantially perpendicular to a central axis of the fastener driver.

The features of the invention believed to be patentable are set forth with particularity in the appended claims. The invention itself, however, both as to organization and method of operation, together with further objects and advantages thereof, may best be understood by reference to the following description taken in conjunction with the accompanying drawings.

### BRIEF DESCRIPTION OF THE DRAWINGS

FIG. 1 is a schematic perspective view of a fastener driver in accordance with the principles discussed herein.

FIG. 2 is a section taken along lines II-II of FIG. 1.

FIG. 3 is a sectional view of the driver illustrated in FIG. 2 engaging a fastener.

FIG. 4 is a sectional view taken generally along lines II-II of FIG. 3.

FIG. 5 is a sectional view of an alternative driver.

FIG. 6 is a sectional view of a driver engaging a worn fastener.

FIG. 7 is a sectional view of alternative embodiment of a driver.

FIG. 8 is a sectional view of the FIG. 7 driver engaging a worn fastener.

### DETAILED DESCRIPTION OF THE INVENTION

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

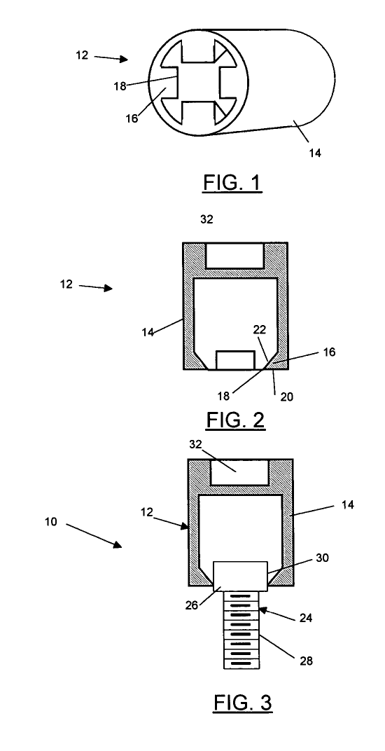

A fastener drive system 10 constructed in accordance with the principles of the present invention is shown in FIGS. 3 through 6. The fastener drive system 10 includes a fastener driver 12 (FIG. 1) having a case 14 with a typical cylindrical exterior configuration. The fastener driver 12 is provided with a plurality of drive blades 16. In this embodiment, each of the drive blades 16 has a generally wedge-shaped cross section terminating in an engagement surface in the form of a drive contact edge 18.

As seen in FIGS. 2 and 3, the drive blades 16 include a bottom surface 20 and an inclined surface 22. The bottom surface 20 of the drive blade 16 is substantially perpendicular to a central axis A of the fastener driver 12.

FIG. 3 shows a fastener 24, also part of the drive system 10. The fastener 24 includes a polygonal drive head 26 and a threaded portion 28. The drive head 26 includes a plurality of external drive surfaces 30. The contact edges 18 of the drive blades 16 engage the external drive surfaces 30 during driving of the fastener 24 by the fastener driver 12. The fastener driver 12 is also provided with a suitable mechanism for attachment to a driver, such as a socket 32 adapted for connection to a typical ratchet wrench (not shown).

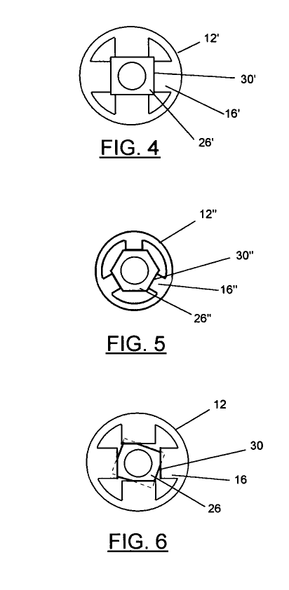

The number of drive blades 16 can correspond to the number of external drive surfaces 30. This correspondence can be direct, one-to-one correspondence, as shown in FIG. 4. In this example, the driver 12′ includes four drive blades 16′ engaging respective drive surfaces 30′ of a four-sided drive head 26′. In FIG. 5, the driver 12″ includes three equally spaced drive blades 16″ engaging three of the six drive surfaces 30″ of the hexagonal drive head 26″, representing a one-to-two correspondence of blades to surfaces.

FIG. 6 illustrates the interaction of a driver 16 engaging a worn fastener 24. Due to the concentration of force along the contact edges 18 due to the wedge shape of the blades 16, the contact edges 18 are able to maintain driving contact with the drive surfaces 26 despite their having been rounded off due to wear. The present invention permits easy removal and replacement of worn fasteners without the need for time-consuming drilling and tapping.

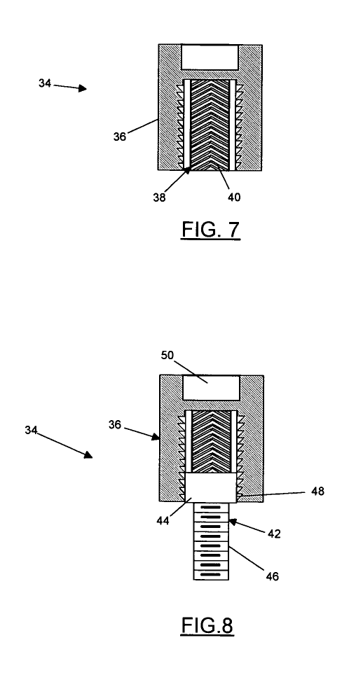

As seen in FIGS. 7 and 8, a drive system 34 can include a drive member 36 The drive member 36 includes a series of drive blades 38. The drive blades 38 are provided with an engagement surface in the form of a series of contact teeth 40. The contact teeth 40 provide additional sharp surfaces having the capacity to dig into fasteners, particularly where the fastener is worn, while lessening the stress at potential weak points of the drive surfaces. Although the contact teeth 40 are shown as having a chevron configuration, the contact teeth can be fabricated in any suitable shape to enhance the gripping action of the engagement surface while reducing stress on the fastener.

FIG. 8 shows a fastener 42, also part of the drive system 34. The fastener 42 includes a polygonal drive head 44 and a threaded portion 46. The drive head 44 includes a plurality of external drive surfaces 48. The contact teeth 40 of the drive blades 38 engage the external drive surfaces 48 during driving of the fastener 42 by the fastener drive member 34. The fastener drive member 34 is also provided with a suitable mechanism for attachment to a driver, such as a socket 50 adapted for connection to a typical ratchet wrench (not shown).

Although the present invention has been described with reference to specific embodiments, those of skill in the art will recognize that changes may be made thereto without departing from the scope and spirit of the invention as defined by the appended claims.

1. A fastener drive system comprising the following:
a fastener including a plurality of external drive surfaces; and
a fastener driver including a plurality of drive blades, each of the drive blades including an engagement surface adapted to engage one of the external drive surfaces during driving of the fastener by the fastener driver.

2. A fastener drive system according to claim 1, wherein the fastener driver comprises a socket adapted for connection to a ratchet driver.

3. A fastener drive system according to claim 2, wherein the plurality of drive blades comprises at least three drive blades.

4. A fastener drive system according to claim 2, wherein the plurality of drive blades comprises at least four drive blades.

5. A fastener drive system according to claim 1, wherein the engagement surface of each drive blade comprises a pair of blade surfaces converging at the contact edge.

6. A fastener drive system according to claim 5, wherein the engagement surface of each drive blade of each drive blade comprise a bottom surface and an inclined surface.

7. A fastener drive system according to claim 1, wherein each of the drive blades comprises a plurality of contact teeth.

8. A fastener drive system according to claim 7, wherein the contact teeth have a chevron shape.

9. A fastener drive system comprising the following:
a fastener including a plurality of external drive surfaces; and
a fastener driver including a plurality of drive blades, each of the drive blades having a generally wedge-shaped cross section and including a contact edge adapted to engage one of the external drive surfaces during driving of the fastener by the fastener driver.

10. A fastener drive system according to claim 9, wherein the fastener driver comprises a cylindrical socket adapted for connection to a ratchet driver.

11. A fastener drive system according to claim 9, wherein the number of drive blades corresponds in number to the number of external drive surfaces.

12. A fastener drive system according to claim 9, wherein the plurality of drive blades comprises at least three drive blades.

13. A fastener drive system according to claim 9, wherein the plurality of drive blades comprises at least four drive blades.

14. A fastener drive system according to claim 9, wherein each of the drive blades comprises a pair of blade surfaces converging at the contact edge.

15. A fastener drive system according to claim 4, wherein the blade surfaces of each drive blade comprise a bottom surface and an inclined surface.

16. A fastener drive system according to claim 14, wherein the bottom surface of the drive blade is substantially perpendicular to a central axis of the fastener driver.

17. A fastener drive system according to claim 9, wherein each of the drive blades comprises a plurality of contact teeth.

18. A fastener drive system according to claim 17, wherein the contact teeth have a chevron shape.
